(19) United States
(12) Patent Application Publication
(10) Pub. No.: US 2004/0199992 A1
(43) Pub. Date: Oct. 14, 2004

(54) Method for mounting a recessed micro jet in a whirlpool bath and a kit therefor

(75) Inventors: Nicolas Lebrun, Saint-Isidore (CA); Steve Donnelly, Sainte-Marie (CA); Bernard Lebrun, Saint-Joseph-de-Levy (CA)

Correspondence Address: OGILVY RENAULT, 1981 MCGILL COLLEGE AVENUE, SUITE 1600, MONTREAL, QC, H3A2Y3, CA

(73) Assignee: MAAX Inc., Sainte-Marie (CA)

(21) Appl. No.: 10/700,595

(22) Filed: Nov. 5, 2003

(30) Foreign Application Priority Data
Apr. 11, 2003 (CA) 2,448,139

(51) Int. Cl. A61H 33/04

(52) U.S. Cl. 4/541.6

(57) ABSTRACT

This invention relates to a method for mounting micro jets on whirlpool bath surfaces. Micro jets are mounted in the bottom of cups. The cup containing the micro jet is mounted in an opening performed in the whirlpool bath shell. The proposed method is specially interesting for jets located on surfaces where fluid flows are obstructed such as the surface where a person's back rests when someone lies in a whirlpool bath. This method allows manufacturers to install micro jets those whirlpool bath surfaces without having a recessed part. Moreover, it allows to modify easily the fluid jet pattern depending on the consumer's needs. The present invention also concerns recessed micro jets for whirlpool baths and method for mounting the same.

### BACKGROUND OF THE INVENTION

a) Field of the Invention

The present invention relates to a method for mounting a recessed micro jet on a whirlpool bath surface, particularly on a slanted wall thereof, and a kit therefore. More particularly, the invention allows to mount a micro jet in a recess position in an opening performed in the whirlpool bath shell. The present invention also concerns a recessed micro jet whirlpool baths and a method for mounting the same.

b) Description of Prior Art

In whirlpool baths, water and/or air jets are disposed in several areas to impart turbulence in the body of water thereby creating acupressure massaging flows. Those whirlpool baths are great for easing away muscular aches and pains in legs, feet or backs.

For aching backs, jets can be positioned on the slanted wall where a person's back lies. Micro jets are usually used instead of normal jets since the power of normal jets is too strong for enjoyable effects. Micro jets are small jets which usually consist of a cylinder having a port extending therethrough and a flange at one extremity of the cylinder. The micro jet cylinder is inserted inside an opening in the whirlpool bath shell in such way that its flange is contiguous to the interior shell. The micro jet cylinder is connected to a pressurized fluid supply.

However, if micro jets are directly positioned on a whirlpool bath surface obstructed by a body part, the relaxing effect is reduced since the fluid flow is obstructed. In U.S. Pat. No. 4,383,340, a whirlpool bath having a recessed part on the surface where a person's back lies is described. Fluid flows from micro jets mounted in the recessed surface are not obstructed by the person lying in the whirlpool bath and allow an efficient massage action.

However, whirlpool bath manufacturers need different bathtub moulds to produce bathtubs with or without recessed parts for clients who may or may not desire whirlpool micro jets behind their back. This implies more important production costs and stock management. Another option is to have only one bathtub mould which produces bathtubs having at least one recessed parts and to fix cover parts over the recessed parts when the client does not desire whirlpool micro jets behind his back. However, with this technique, the bathtub esthetic aspect is reduced since it is impossible to mask completely the joints between both parts. Therefore, the resulting esthetic aspect of the bathtub displeases several clients who do not desire whirlpool micro jets behind their back.

There therefore exists a need for a new method to dispose micro jets in whirlpool baths, that allows to use the same bathtub mould, without negative esthetic aspect, and permits the production of bathtubs with or without whirlpool micro jets on an obstructed surface, while making sure that the micro jet disposition should allow efficient fluid flows.

### SUMMARY OF THE INVENTION

It is an object of the present invention to overcome the problems mentioned previously.

It is another object of the present invention to provide a method for mounting a micro jet in a whirlpool bath which affords an efficient water and/or air flow even if a body part lies on the surface of the bath where the micro jet is mounted.

It is yet another object of the present invention to provide a method for mounting micro jets in whirlpool baths in which the same mould is used to produce bathtubs with or without whirlpool micro jets on a surface that can be obstructed by a body part, without displeasing esthetic aspects.

It is another object of the present invention to provide a kit including recessed micro jets that allow efficient water and/or air distribution even if a body part lies on the surface where a micro jet is mounted.

The above and other objects of the present invention may be achieved by providing a method for mounting a massaging micro jet in a slanted wall of a whirlpool bath, in a recessed position relative to the slanted surface, which comprises

a) providing a massaging micro jet,

b) providing a massaging micro jet holding cup, the cup being formed with means for mounting same on the slanted wall and a cavity having a recessed bottom partition, the cup having means to fix the micro jet through the recessed bottom partition with the micro jet oriented in a substantially horizontal direction,

c) performing an opening in said slanted wall,

d) inserting said cup through said opening and fixing same substantially flush with said opening by means of said mounting means,

e) introducing said micro jet into said cup, orienting said micro jet in a substantially horizontal direction, and fixing same in said recessed bottom partition by means of said fixing means, and

f) connecting said micro jet to a pressurized fluid supply.

The invention also relates to a kit for mounting a massaging micro jet in a slanted wall of a whirlpool bath, in a recessed position relative to the slanted surface, which comprises

a) a massaging micro jet,

b) a massaging micro jet holding cup, the cup formed with means for mounting same on the slanted wall and a cavity having a recessed bottom partition, the cup having means to fix the micro jet through the recessed bottom partition and orientable in a substantially horizontal direction,

c) means for fixing the holding cup substantially flush with the opening by means of the mounting means, and

d) means for connecting the micro jet to a pressurized fluid supply.

The invention also relates to a recessed massaging micro jet for slanted wall of a whirlpool bath. The recessed micro jet comprises a cup portion having a mounting flange provided at free end thereof and formed with a cavity and a recessed bottom partition. It also comprises a cylindrical member dependent from the recessed bottom partition and extending past an outer surface of the recessed bottom partition. The cylindrical member has a port extending therethrough. The port terminates into an aperture on an inner surface of the recessed bottom partition.

The invention also concerns a method for mounting a recessed massaging micro jet. The method comprises the following steps:

a) providing a recessed massaging micro jet according to the previous object of the present invention,

b) performing an opening in the slanted wall,

c) inserting the recessed micro jet through the opening and fixing same substantially flush with the opening, and

d) connecting the micro jet circular port to a pressurized fluid supply.

### BRIEF DESCRIPTION OF THE DRAWINGS

FIG. 1 represents a perspective view of a micro jet and a holding cup being mounted on a slanted wall; and

FIG. 2 represents a perspective view of the circular port and polygonal grip of the micro jet and the central aperture of the holding cup.

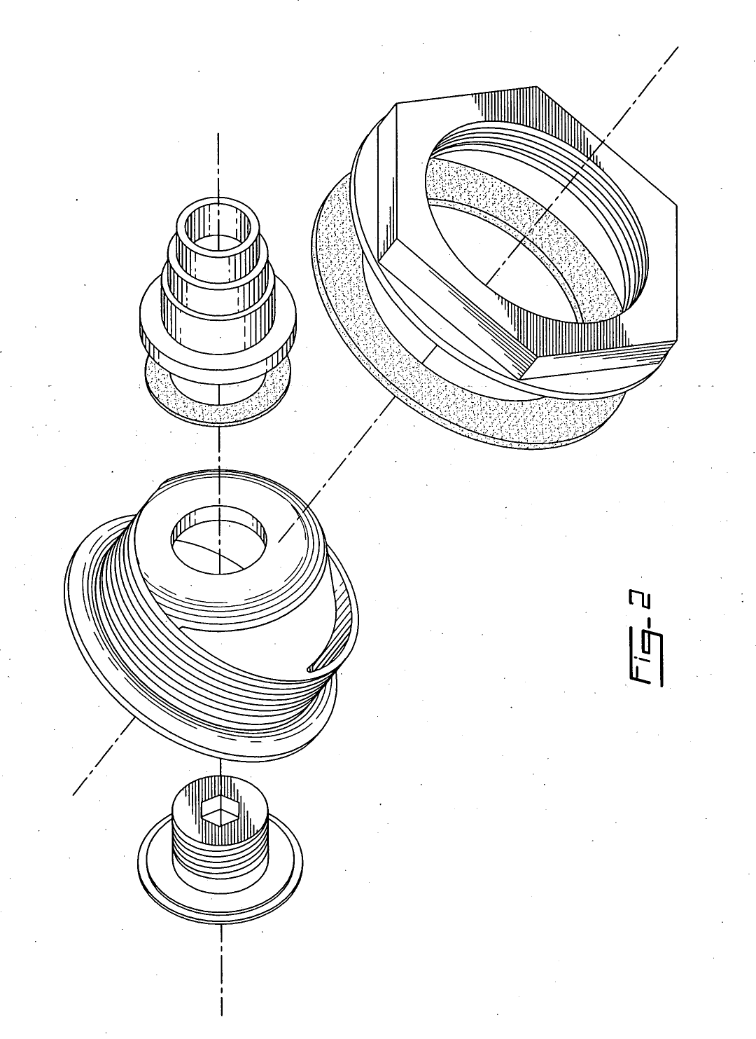

### DESCRIPTION OF PREFERRED EMBODIMENT

The method according to the invention may be achieved by providing a kit that will enable to mount a massaging micro jet in the slanted wall of a whirlpool bath.

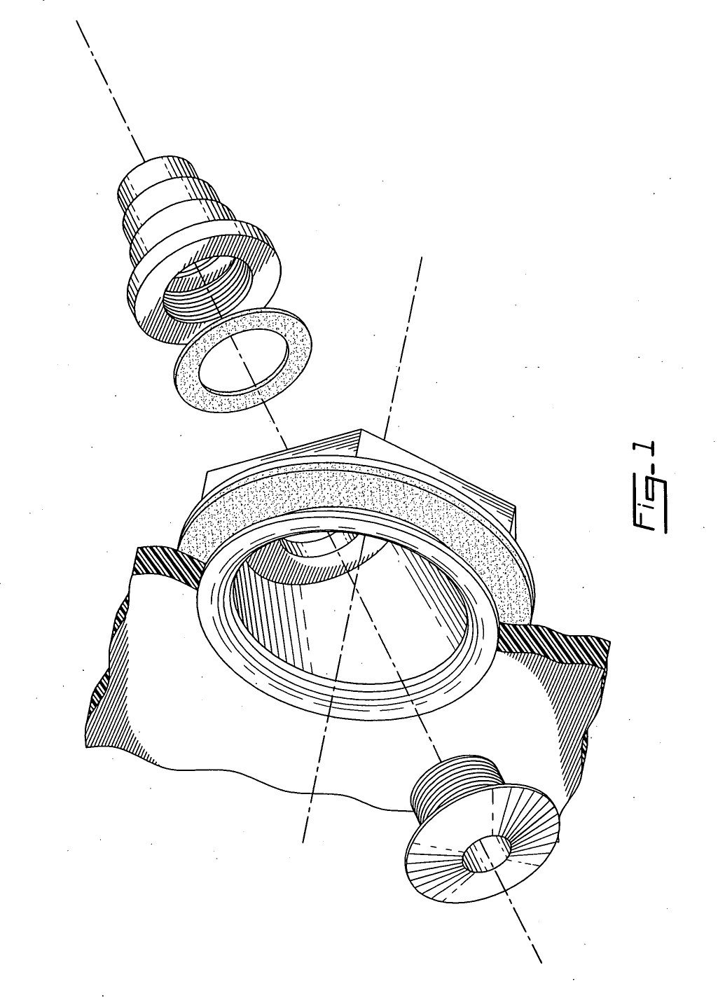

The kit is particularly illustrated in FIG. 1 and will now be described in detail. Kit 1 essentially comprises a massaging micro jet 3 of standard construction. As shown, micro jet 3 consists of a cylindrical member 5 having a circular port 7 extending throughout its length. Cylindrical member 5 is provided at one free end with a fixing flange 9, the purpose of which will be discussed more in detail when describing the method of mounting micro jet 3 in the slanted wall 11 of a whirlpool bath (not shown). It will also be noted that cylindrical member 5 has a thread 13 (referred to in the claims as the first thread) of standard design that is used for connecting the micro jet to a pressurized fluid supply (here water) by means of a connector 15, which is ideally a jet body. Finally, it will be noted that at the end of port 7 opposite fixing flange 9, there is a polygonal (here hexagonal) grip 17 which enables to prevent micro jet 3 from rotating by inserting a holding tool well known to those skilled in the art, into hexagonal grip 17, when assembling micro jet 7 with connector 15.

To mount micro jet 3 in slanted wall 11 of the whirlpool bath, there is provided a massaging micro jet holding cup 19 that will new be described in detail. Holding cup 19 is a specially designed device that consists of a first cylindrical portion 21 and a second cylindrical portion 23. In the illustrated embodiment, it will be noted that second cylindrical portion 23 has a shorter diameter than first cylindrical portion 21. This may of course vary substantially depending on the preference of the designer. It will also be noted that first cylindrical portion 21 and second cylindrical portion 23 are connected in the continuation of one another and in such a manner that their respective axes 25 and 27 meet at an angle, here approximately 90-θ degrees, wherein θ is the slope of slanted wall 11, the reason being that holding cup 19 is mounted on slanted wall 11 and that second cylindrical portion 23 is used for mounting micro jet 3 and directing its flow of fluid (here water) horizontally as will be described later.

Referring again to holding cup 19, it will be seen that cylindrical portion 21 has a mounting flange 29 at its free end and a thread 31 (referred to in the claims as the second thread) that is formed all along its outer surface. With respect to cylindrical portion 23, it is formed with a bottom partition 33 at the free end thereof, and the latter comprises a central aperture 35 that is designed to accommodate cylindrical member 5 of micro jet 3 when assembling the kit.

To complete the kit, there is provided a seal ring 37 that is shaped to fit exactly over thread 31 and to rest tight against the outer surface 39 of slanted wall 11, and a flange nut 41 that is screwable over thread 31 with its flange 43 (29?) in contact with the inner surface 40 of slanted wall 11. There is additionally provided a second seal ring 45 that is engageable over thread 13 and is designed to rest against outer surface of bottom partition 33 when assembling the kit. Connector 15 on the other hand is inwardly threaded at 47 to be engaged with thread 13 of cylindrical member 5.

The whirlpool bath is manufactured with a slanted back wall without recessed parts that is esthetically attractive. If a client wishes to have a micro jet in slanted back wall 11, he is supplied with a kit as described above and the manufacturer will provide slanted wall 11 with an opening 49 that is shaped to receive holding cup 19.

Micro jet 3 and holding cup 19 are made of plastic, stainless steel or any other material known to one skilled in the art.

To mount massaging micro jet 3 after opening 41 has been formed, holding cup 19 is pushed through opening 49 until mounting flange 29 rests against the inner surface of slanted wall 11 all around opening 41. Then, seal ring 37 is placed over thread 31 until it rests against the outer surface 39 of slanted wall 11. Flange nut 41 is then screwed over thread 31 until flange 43 is tight against inner surface of slanted wall 11 and the latter is in fluid proof firm contact with the inner surface of slanted wall 11. Once this is completed, micro jet 3 is fixed into holding cup 3 by inserting cylindrical member 5 thereof through central aperture 35 until fixing flange 9 rests against the inner surface of bottom partition 33. Seal ring 45 is disposed around thread 13 of cylindrical member 5 until it rests against the outer surface of bottom partition 33.

Finally with a special tool (not shown) that is introduced into polygonal grip 17, micro jet 3 is prevented from rotating and threaded connector 15 is threaded over thread 13 until it is firmly and sealingly engaged with micro jet 3: Connector 15 is then linked in known manner to a source of a fluid under pressure, here water.

Micro jet 3 and holding cup 19 can be molded together, in one piece, (referred to in the claims as recessed micro jet) thus eliminating the need to fix and seal micro jet 3 with cup 19.

It is understood that this kit and the method for mounting same can be used anywhere in a wall of a whirlpool as will be appreciated by one skilled in the art.

It is understood that the invention is not restricted to the above embodiments and that many modifications are possible within the scope of the appended claims.

We claim:

1. Method for mounting a massaging micro jet in a slanted wall of a whirlpool bath, in a recessed position relative to said slanted wall, which comprises
a) providing a massaging micro jet,
b) providing a massaging micro jet holding cup, said holding cup formed with means for mounting same on said slanted wall and a cavity having a recessed bottom partition, said cup having means to fix said micro jet through said recessed bottom,
c) performing an opening in said slanted wall,
d) inserting said holding cup through said opening and fixing same substantially flush with said opening by means of said mounting means,
e) introducing said micro jet into said cup and fixing same in said recessed bottom partition by means of said fixing means, and
f) connecting said micro jet to a pressurized fluid supply.

2. Method according to claim 1, wherein said massaging micro jet comprises a cylindrical member having a port extending therethrough and a fixing flange provided at a free end thereof.

3. Method according to claim 2, wherein said holding cup comprises a mounting flange provided at free end thereof and a bottom partition having an aperture therein shaped to receive said micro jet, said method comprising resting said fixing flange against an inner surface of said bottom partition and allowing said cylindrical member to extend through said aperture.

4. Method according to claim 3, wherein said holding cup comprises a first cylindrical portion, and a second cylindrical portion communicating with said first cylindrical portion and angularly disposed with respect to the axis of said first cylindrical portion, wherein said first cylindrical portion comprises said mounting flange provided at a free end thereof and said second cylindrical portion comprises said bottom partition having said aperture.

5. Method according to claim 4, wherein said first and second cylindrical portions are disposed angularly.

6. Method according to claim 5 wherein a part of said cylindrical portion close to said mounting flange has a second thread formed along an outer surface thereof.

7. Method according to claim 6, which comprises fixing said holding cup into said opening by resting said mounting flange against the inner surface of said slanted wall, disposing a first seal ring around said cylindrical portion against the outer surface of said slanted wall, and screwing a flange nut over said second thread tight against said first seal ring.

8. Method according to claim 7, wherein said cylindrical member has a first thread extending along its outer surface.

9. Method according to claim 8, which comprises fixing said micro jet into said holding cup by inserting said cylindrical member through said aperture until said fixing flange rests against the inner surface of said bottom partition, disposing a second seal ring around said cylindrical member against the outer surface of said bottom partition, and screwing a connector over said first thread against said second seal ring.

10. Method according to claim 5, wherein said cylindrical member has a first thread extending along its outer surface.

11. Method according to claim 10, which comprises fixing said micro jet into said holding cup by inserting said cylindrical member through said aperture until said fixing flange rests against inner surface of said bottom partition, disposing a second seal ring around said cylindrical member against the outer surface of said bottom partition, and screwing a connector over said first thread against said second seal ring.

12. A kit for mounting a massaging micro jet in a slanted wall of a whirlpool bath, in a recessed position relative to said slanted wall, which comprises
a) a massaging micro jet,
b) a massaging micro jet holding cup, said holding cup formed with means for mounting same on said slanted wall and a cavity having a recessed bottom partition, said holding cup having means to fix said micro jet through said recessed bottom partition,
c) means for fixing said holding cup substantially flush with said opening by means of said mounting means, and
d) means for connecting said micro jet to a pressurized fluid supply.

13. The kit according to claim 12, wherein said massaging micro jet comprises a cylindrical member having a port extending therethrough and a fixing flange provided at a free end thereof.

14. The kit according to claim 13, wherein said holding cup comprises a mounting flange provided at free end thereof and a bottom partition having an aperture therein shaped to receive said micro jet by having said fixing flange resting against an inner surface of said bottom partition and said cylindrical member extending through said aperture.

15. The kit according to claim 14, Wherein said holding cup comprises a first cylindrical portion, and a second cylindrical portion communicating with said first cylindrical portion and angularly disposed with respect to the axis of said first cylindrical portion, wherein said first cylindrical portion comprises said mounting flange provided at a free end thereof and said second cylindrical portion comprises said bottom partition having said aperture.

16. The kit according to claim 15, wherein said first and second cylindrical portions are disposed angularly in such way that the direction of said fluid exhausting from said micro jet port is substantially horizontal.

17. The kit according to claim 16, wherein a part of said cylindrical portion close to said mounting flange has a second thread formed along an outer surface thereof.

18. The kit according to claim 17, which comprises a first seal ring to be disposed around said cylindrical portion flat against the outer surface of said slanted wall, and a flange nut screwable over said second thread tight against said first seal ring.

19. The kit according to claim 18, wherein said cylindrical member has a first thread extending along its outer surface.

20. The kit according to claim 19, which comprises a second seal ring to be disposed around said cylindrical member against the outer surface of said bottom (partition?), and said connecting means comprises a pressurized fluid connector screwable over said first thread against said second seal ring.

21. The kit according to claim 16, wherein said cylindrical member has a first thread extending along its outer surface.

22. The kit according to claim 21, which comprises a second seal ring to be disposed around said cylindrical member against the outer surface of said bottom (partition?), and said connecting means comprises a pressurized fluid connector screwable over said first thread against said second seal ring.

23. A recessed massaging micro jet for slanted wall of a whirlpool bath, which comprises a cup portion having a mounting flange provided at free end thereof and formed with a cavity and a recessed bottom partition, and a cylindrical member dependent from said recessed bottom partition and extending past an outer surface of said recessed bottom partition, said cylindrical member having a port extending therethrough, said port terminating into an aperture on an inner surface of said recessed bottom partition.

24. A recessed massaging micro jet according to claim 23, wherein said cup comprises a first cylindrical portion, and a second cylindrical portion communicating with said first cylindrical portion and angularly disposed with respect to the axis of said first cylindrical portion, wherein said first cylindrical portion comprises said mounting flange provided at a free end thereof and said second cylindrical portion comprises said recessed bottom partition where said port aperture is formed.

25. A recessed massaging micro jet according to claim 24, wherein said first and second cylindrical portions are disposed angularly in such way that the direction of said fluid exhausting from said port aperture is substantially horizontal.

26. A recessed massaging micro jet according to claim 25, wherein a part of said cylindrical portion close to said mounting flange has a second thread formed along an outer surface thereof.

27. A recessed massaging micro jet according to claim 26, wherein said cylindrical member close to said mounting flange has a first thread extending along an outer surface thereof.

28. Method for mounting a recessed massaging micro jet, comprising:
a) providing a recessed massaging micro jet according to claim 23,
b) performing an opening in said slanted wall,
c) inserting said recessed micro jet through said opening and fixing same substantially flush with said opening, and
d) connecting said micro jet to a pressurized fluid supply.

29. Method according to claim 28, which comprises disposing a first seal ring around said cylindrical portion against the outer surface of said slanted wall, and screwing a flange nut over said second thread tight against said first seal ring.

30. Method according to claim 29, which comprises disposing a second seal ring around said cylindrical member, and screwing a connector over said first thread until said second seal ring abuts outer surface of said bottom partition.
